(19) United States
(12) Patent Application Publication
(10) Pub. No.: US 2011/0242432 A1
(43) Pub. Date: Oct. 6, 2011

(54) ELECTRONIC DEVICE AND CONTROL METHOD

(75) Inventors: Nobuaki SUZUKI, Tokyo (JP); Isao SUZUKI, Tokyo (JP)

(73) Assignee: Kabushiki Kaisha Toshiba, Tokyo (JP)

(21) Appl. No.: 13/031,069

(22) Filed: Feb. 18, 2011

(30) Foreign Application Priority Data
Mar. 31, 2010 (JP) 2010-084357
Oct. 26, 2010 (JP) 2010-240167

(51) Int. Cl. H04N 5/44; H04Q 5/22

(52) U.S. Cl. 348/734; 340/10.1; 348/E05.096

(57) ABSTRACT

In one embodiment, there is provided an electronic device. The electronic device includes: a first communication module configured to: transmit a confirmation request to an external device to confirm whether the external device supports an operation command or not; and receive, from the external device, a response including information as to whether the external device supports the operation command or not; a receiver configured to receive a remote controller signal from a remote controller; a second communication module configured to transmit the operation command corresponding to the remote controller signal, to the external device; and a reporting module configured to report that the operation command is not supported by the external device, when the response includes the information that the operation command is not supported by the external device.

### CROSS-REFERENCE TO RELATED APPLICATION

This application claims priority from Japanese Patent Application No. 2010-084357, filed on Mar. 31, 2010, the entire contents of which are hereby incorporated by reference.

### BACKGROUND

1. Field

Embodiments described herein generally relate to an electronic device and a control method.

2. Description of the Related Art

HDMI (High Definition Multimedia Interface) is an example of a digital interface for connecting a video display device such as a television set and a video output device such as a player to each other. The HDMI includes standards defined about mutual control between devices, called CEC (Consumer Electronics Control). In the HDMI-CEC, a device which has received one of various signals from a remote controller can control an external device by transmitting a control command corresponding to the received signal to the external device through an HDMI cable.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a view showing a display device and a video output device according to a first embodiment of the invention;

FIG. 2 is a diagram showing an example of a system configuration of the display device, the video output device and a remote controller according to the first embodiment of the invention;

FIGS. 3A to 3D are views showing data configuration examples of messages to be transmitted/received by the display device and the video output device according to the first embodiment of the invention;

FIGS. 4A and 4B are views showing data structure examples of databases stored in the display device according to the first embodiment of the invention;

FIG. 5 is a chart showing an example of a processing flow of database registration to be performed by the display device according to the first embodiment of the invention;

FIG. 6 is a chart showing an example of a processing flow of database registration to be performed by the display device according to the first embodiment of the invention;

FIG. 7 is a chart showing an example of a processing flow about reception of a remote controller signal to be performed by the display device according to the first embodiment of the invention;

FIG. 8 is a chart showing an example of a processing flow about transmission of a response message to be performed by the video output device according to the first embodiment of the invention;

FIG. 9 is a chart showing an example of a processing flow about transmission of a response message to be performed by the video output device according to the first embodiment of the invention;

FIG. 10 is a view showing an example of a processing sequence to be performed by the display device, the video output device and the remote controller according to the first embodiment of the invention;

FIG. 11 is a view showing a display device and a video output device according to a second embodiment of the invention;

FIG. 12 is a diagram showing an example of a system configuration of the display device, the video output device and a remote controller according to the second embodiment of the invention;

FIGS. 13A to 13C are views showing an example of a report operation executed by the display device according to the second embodiment of the invention;

FIGS. 14A to 14C are views showing an example of a report screen displayed by the display device according to the second embodiment of the invention; and

FIG. 15 is a chart showing an example of a processing flow about the report screen displayed the display device according to the second embodiment of the invention.

### DETAILED DESCRIPTION

### First Embodiment

According to exemplary embodiments of the present invention, there is provided an electronic device. The electronic device includes: a first communication module configured to: transmit a confirmation request to an external device to confirm whether the external device supports an operation command or not; and receive, from the external device, a response including information as to whether the external device supports the operation command or not; a receiver configured to receive a remote controller signal from a remote controller; a second communication module configured to transmit the operation command corresponding to the remote controller signal, to the external device; and an execution module configured to execute a specific processing, depending on whether the external device supports the operation command or not.

An embodiment of the invention will be described below with reference to the drawings.

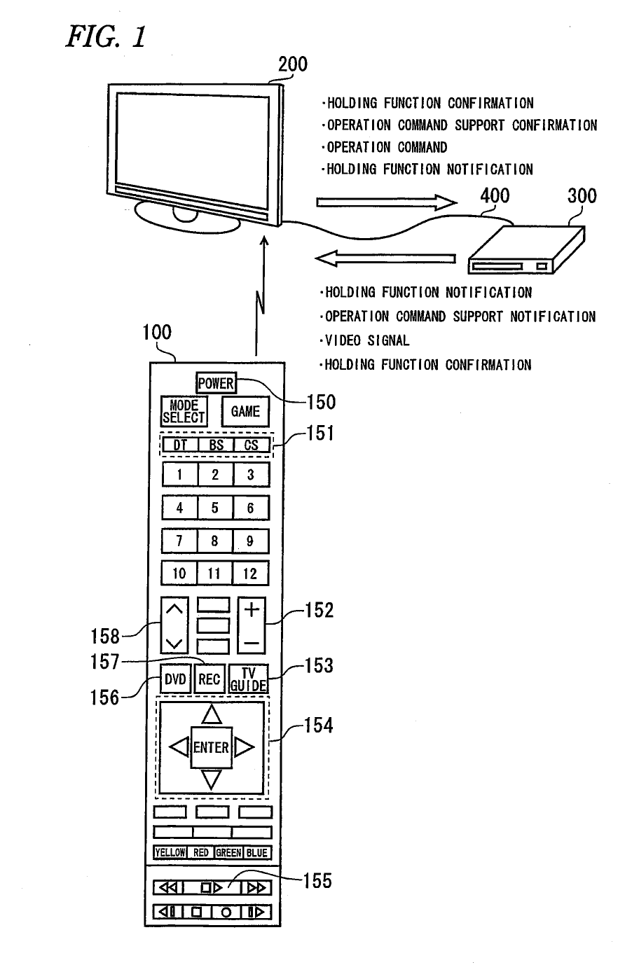

FIG. 1 is a view showing an example of an electronic device system according to the embodiment. An electronic device according to the embodiment is implemented, for example, as a combination of a display device 200 and a video output device 300.

The display device 200 and the video output device 300 are connected to each other by an HDMI cable 400. The display device 200 has a function of displaying video outputted from the video output device 300. The display device 200 can further receive one of various signals transmitted from a remote controller 100 and having a remote controller code superposed thereon, and can output a control command corresponding to the remote controller code of the signal to the video output device 30 through the HDMI cable 400 to thereby control operation of the video output device 300.

More specifically, when, for example, the remote controller 100 receives an operation on a program guide button 153, the remote controller 100 transmits a signal on which a remote controller code corresponding to the button is superposed, to the display device 200. Upon reception of this signal, the display device 200 transmits a control command corresponding to the remote controller code superposed on this signal, i.e. a control command for displaying a program guide, to the video output device 300. Upon reception of the control command, the video output device 300 outputs a video image of the program guide to the display device 200.

When there is an operation on any other button such as a play button 155 or a DVD menu display button 156 than the program guide button 153, the remote controller 100 transmits a signal with a remote controller code corresponding to the button to the display device 200. The display device 200 transmits a control command corresponding to the remote controller code of the received signal to the video output device 300. The video output device 300 performs processing in accordance with the received control command.

Even when the video output device 300 receives the control command sent by the display device 200, the video output device 300, however, may be unable to execute processing in accordance with the control command because the control command is not supported by the video output device 300.

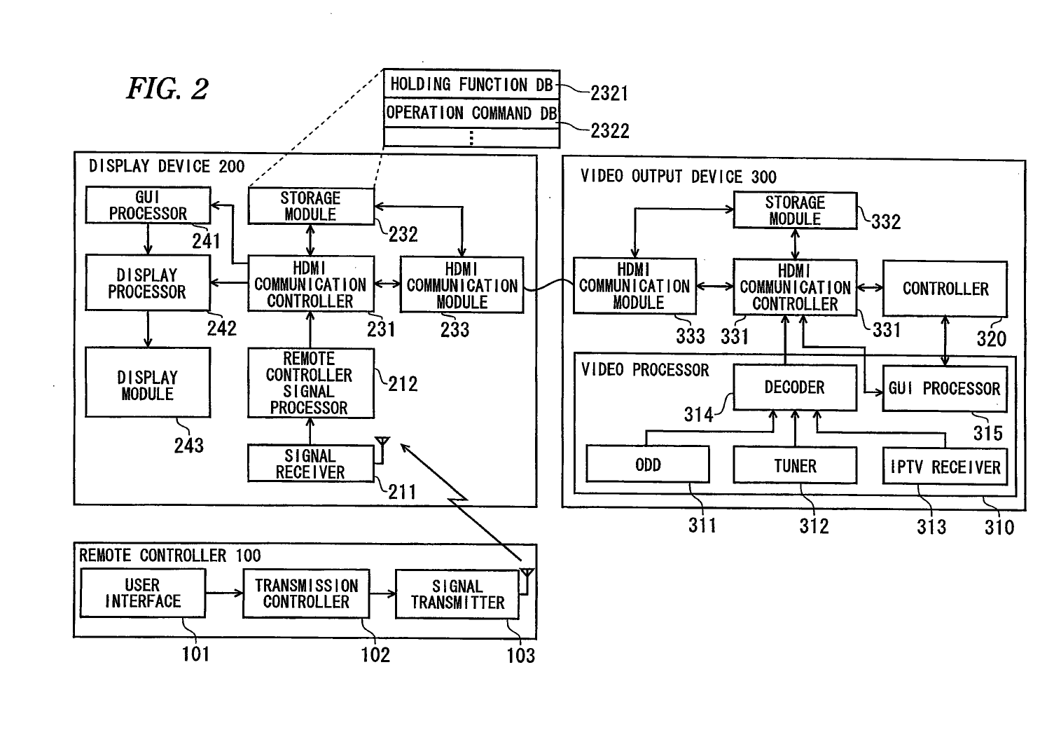

On the contrary, the display device 200 according to this embodiment transmits a confirmation message (command) to the video output device 300 to inquire whether various control commands are supported by the video output device 300 or not, and receives a response message (command) to the confirmation message from the video output device 300 to thereby determine control commands supported (executable) by the video output device 300. When the display device 200 receives one of various signals from the remote controller 100, the display device 200 executes processing in accordance with whether a control command corresponding to the remote controller code of the signal is supported by the video output device 300 or not, so that user-friendliness can be improved. Details about this will be described below with reference to FIGS. 2 to 10.

FIG. 2 is a diagram showing an example of system configuration of the remote controller 100, the display device 200 and the video output device 300.

The remote controller 100 will be described first.

The remote controller 100 has a user interface 101, a transmission controller 102, and a signal transmitter 103. The user interface 101 has a function of accepting any one of various operation inputs from a user. The transmission controller 102 generates a remote controller code corresponding to the operation input accepted by the user interface 101 and controls the signal transmitter 103 to transmit a signal including the remote controller code superposed thereon.

The display device 200 will be described next.

The display device 200 has a signal receiver 211, a remote controller signal processor 212, an HDMI communication controller 231, a storage module 232, an HDMI communication module 233, a GUI processor 241, a display processor 242, and a display module 243.

The signal receiver 211 receives a single from the remote controller 100. The remote controller signal processor 212 processes a remote controller code superposed on the signal received by the signal receiver 211, and outputs the remote controller code to the HDMI communication controller 231.

The HDMI communication controller 231 controls processing concerned with establishment of HDMI communication connection with the video output device 300 connected through the HDMI cable 400, transmission/reception of any command to/from the video output device 300, reception of video data from the video output device 300, etc.

In the HDMI communication connection establishment processing, the HDMI communication controller 231 acquires HDCP (High-Bandwidth Digital Contents Protection) key information stored in a storage module 332 of the video output device 300 connected through the HDIMI cable 400.

In addition, the HDMI communication controller 231 transmits a holding function confirmation message and an operation command support confirmation message to the video output device 300 through the HDMI communication module 233 to inquire of the video output device 300 about functions provided by the video output device 300 and inquire of the video output device 300 about operation commands supported by the video output device 300.

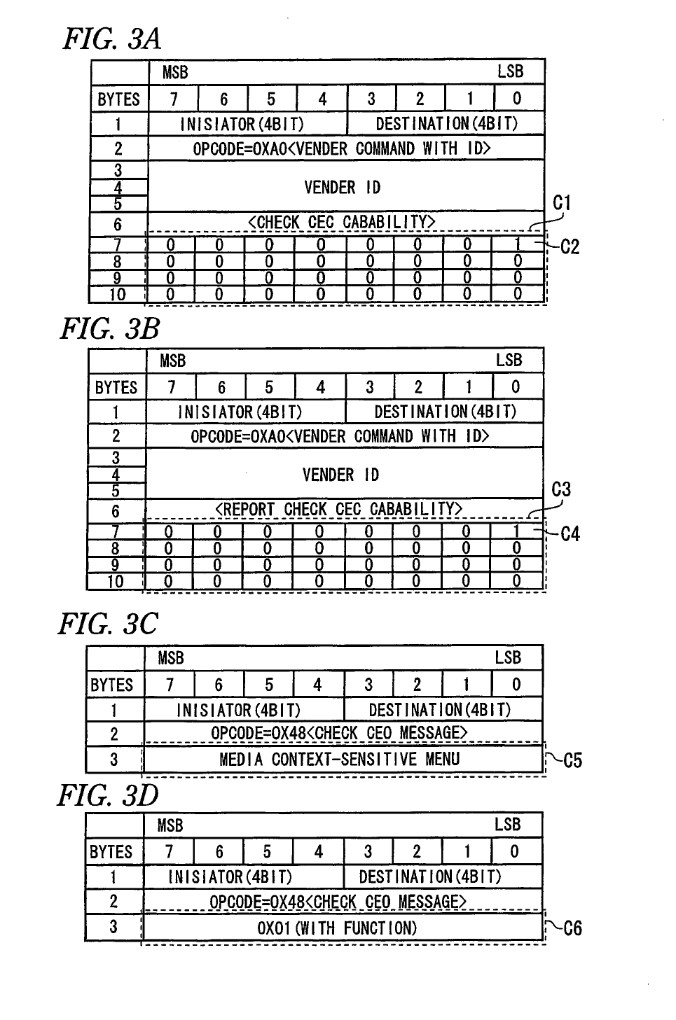

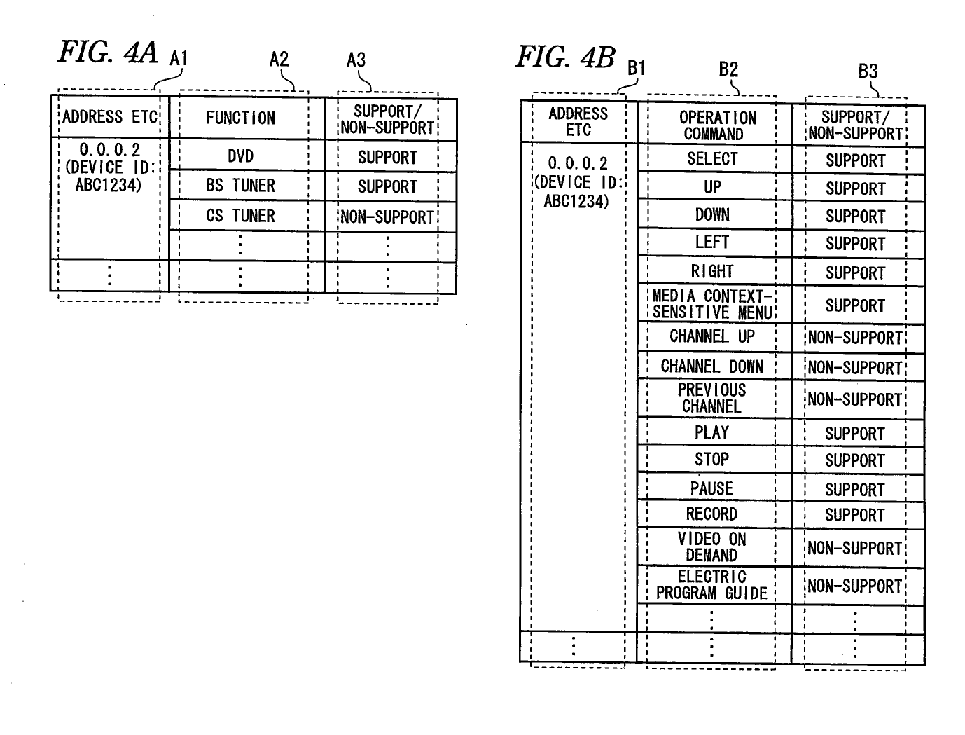

Successively, upon reception of a response to the holding function confirmation message and a response to the operation command support confirmation message, the HDMI communication controller 231 creates a holding function database 2321 and an operation command database 2322 based on the responses and stores the databases 2321 and 2322 in the storage module 232. Incidentally, the holding function confirmation message, the operation command support confirmation message and these databases based on these messages will be described later with reference to FIGS. 3A to 3D and FIGS. 4A and 4B.

When a remote controller code is provided from the remote controller signal processor 212 but the video output device 300 does not support an operation command corresponding to the remote controller code, the HDMI communication controller 231 instructs the GUI processor 241 to create a report screen. When the video output device 300 does not support an operation command corresponding to the remote controller code provided from the remote controller signal processor 212, the HDMI communication controller 231 may instruct not only the GUI processor 241 to create a report screen but also a speaker module (not shown) to report so that an alarm sound is outputted from the speaker module. Processing executed by the display device 200 when the video output device 300 does not support the operation command is not limited to the aforementioned processing. The display device 200 may perform processing differentiated between the case where the video output device 300 does not support the operation command corresponding to the input remote controller code and the case where the video output device 300 supports the operation command, so that the display device 200 can make a user recognize the fact that the video output device 300 does not support the remote controller code.

Further, upon reception of video data after the HDMI communication connection establishment processing, the HDMI communication controller 231 decrypts the video data based on an encryption key stored in the storage module 232 and an encryption key acquired from the video output device 300. The HDMI communication controller 231 outputs the decrypted video data to the display processor 242.

The storage module 232 has a function of storing HDCP encryption key information, video format information, the holding function database 2321, the operation command database 2322, etc. The HDCP encryption key information is information of an encryption key applied to video data when the video output device 300 transmits the video data to the display device 200. The video format information is information of a video format of video data capable of being displayed by the display device 200.

Upon reception of a report screen creation instruction from the HDMI communication controller 231, the GUI processor 241 creates a report screen based on the instruction, and outputs data of the screen to the display processor 242.

The display processor 242 generates a video signal based on the video data provided from the HDMI communication controller 231 or the screen data provided from the GUI processor 241, and outputs the video signal to the display module 243. The display module 243 displays video based on the video signal provided from the display processor 242.

Successively, the video output device 300 will be described.

The video output device 300 has an ODD 311, a tuner 312, an IPTV receiver 313, a decoder 314, a GUI processor 315, a controller 320, an HDMI communication controller 331, a storage module 332, and an HDMI communication module 333.

The ODD 311 has a function of reading video data recorded on an optical disk. The ODD 311 outputs the read video data to the decoder 314. The tuner 312 has a function of receiving a television broadcast signal for digital terrestrial or BS/CS broadcasting, etc. The tuner 312 acquires video data superposed on the television broadcast signal, and outputs the video data to the decoder 314. The IPTV receiver 313 has a function of acquiring IPTV video data through a network. The IPTV receiver 313 outputs the acquired IPTV video data to the decoder 314. The decoder 314 decodes the input video data, and outputs the decoded video data to the HDMI communication controller 331.

The GUI processor 315 has a function of creating a menu screen etc., for example, for operating a program guide or a DVD, and outputting the screen to the HDMI communication controller 331.

The controller 320 controls the respective functional blocks included in the video processor 310. That is, the controller 320 instructs the respective functional blocks of the video processor 310 to execute processing in accordance with an instruction given from the HDMI communication controller 331.

The HDMI communication controller 331 has a function of establishing HDMI communication connection with the display device 200 and processing video data, HDMI-CEC-based control commands, etc. The HDMI communication controller 331 acquires the HDCP encryption key information, the video format information, etc. stored in the storage module 232 of the display device 200 through the HDMI communication module 333 when the HDMI communication connection is established.

Upon reception of video data from the decoder 314 after establishment of the HDMI communication connection, the HDMI communication controller 331 decrypts the video data based on an encryption key stored in the storage module 332 and an encryption key acquired from the display device 200, and transmits the video data to the display device 200 through the HDMI communication module 333.

Upon reception of a holding function confirmation message or an operation command support confirmation message from the display device 200, the HDMI communication controller 331 determines operation commands supported by the video output device 300 or functions held by the video output device 300, and transmits a message in accordance with a result of the determination to the display device 200.

Upon reception of an operation command etc. from the display device 200, the HDMI communication controller 331 instructs the controller 320 to execute processing in accordance with the command.

The holding function confirmation message and the operation command support confirmation message transmitted to the video output device 300 by the display device 200 will be described next with reference to FIGS. 3A to 3D.

FIG. 3A is a view showing a configuration example of the holding function confirmation message. In this message, one function can be associated with each bit of data regions (of 4 bytes each having bits 0-7) on lines 7-10 as represented by C1. When the display device 200 transmits the message to the video output device 300 while “1” is stored in the data region, the display device 200 can confirm whether or not the video output device 300 has a function corresponding to the data region in which “1” is stored.

FIG. 3B is a view showing a data configuration example of a holding function notification message transmitted, as a response to the holding function confirmation message, to the display device 200 by the video output device 300. In the holding function notification message, one function is associated with each bit of data regions (of 4 bytes each having bits 0-7) on lines 7-10 as represented by C3 similarly to the holding function confirmation message shown in FIG. 3A. When the video output device 300 transmits the message to the display device 200 while “1” is stored in the data region, the display device 200 can be notified of the fact that the video output device 300 has a function corresponding to the data region in which “1” is stored.

The function associated with each of the data regions C3 is the same as the function associated with each of the data regions C1. Correspondence between these data regions and functions is, for example, defined and stored in the storage portions 232 and 332.

That is, in the display device 200 and the video output device 300, for example, a data region C2 is defined as a region for inquiring whether a DVD function is provided or not When the display device 200 transmits the holding function conformation message to the video output device 300 while “1” is stored in the data region C2, and the video output device 300 receives the message, the video output device 300 determines whether a DVD function is provided or not, and sends a holding function notification message back to the display device 200 while “1” or “0” is stored in a data region C4 in accordance with a result of the determination.

In the holding function confirmation/notification message, for example, a DVD function, a BS tuner, a CS tuner, an IPTV reception function, etc. can be defined in association with the data regions C1 respectively.

Next, data configuration examples of an operation command support confirmation message and an operation command support notification message will be described with reference to FIGS. 3C and 3D.

FIG. 3C is a view showing a data configuration example of an operation command support confirmation message to be transmitted to the video output device 300 by the display device 200. In this message, the name of an operation command for confirmation as to whether the video output device 300 supports the operation command or not, is stored in a data region as represented by C5, so that the display device 200 can inquire whether the video output device 300 supports the operation command or not.

FIG. 3D is a view showing a data configuration example of an operation command support notification message to be transmitted to the display device 200 by the video output device 300. This message can be sent back while information indicating whether the video output device 300 supports the operation command designated (requested for confirmation) by the operation command confirmation message shown in FIG. 3C is stored in a data region C6. Incidentally, when the video output device 300 supports the operation command designated by the confirmation message, the operation command support notification message may include information indicating the fact that the video output device 300 supports the operation command, and information indicating the version of the supported operation command.

In the operation command support confirmation message and the operation command support notification message, for example, it is possible to make an inquiry/notification as to whether the video output device 300 supports various operation commands described in CEC Table 30 User Control Codes of HDMI Specification ver. 1.4 or not—Incidentally, the operation commands which can be inquired in the operation command support confirmation message are not limited to the aforementioned commands. For example, an inquiry may be made about various operation commands defined by a vender. The video output device 300 may send the display device 200 information in which an ID, a device name or the like of each device is contained in the holding function notification message and the operation command support confirmation message

The display device 200 sends the message shown in FIG. 3C to the video output device 300 so as to inquire whether one operation command stored in the data region CS is supported or not. Meanwhile, by sending a message in which operation commands are defined to be associated with data regions respectively, e.g. like the massage shown in FIG. 3A, so that one message can be used for inquiring the video output device 300 about whether operation commands are supported or not.

Next, the holding function database 2321 and the operation command database 2322 will be described with reference to FIGS. 4A and 4B.

FIG. 4A is a view showing a configuration example of the holding function database 2321. In the database, an address of each device connected to the display device 200, an ID of the device or the like is stored in a data region A1. Information indicating functions is stored in a data region A2 in accordance with each device stored in the data region A1. Information indicating whether the device has (supports) the functions shown in the data region A2 or not, is stored in a data region A3.

FIG. 4B is a view showing a configuration example of the operation command database 2322. In this database, an address of each device connected to the display device 200, an ID of the device or the like is stored in a data region B1. Information indicating operation commands is stored in a data region B2 in accordance with each device stored in the data region B1. Information indicating whether the device supports each of the operation commands indicated in the data region B2 or not, is stored in a data region B3. As described above, the operation commands are various operation commands described in the CEC Table 30 User Control Codes of HDMI Specification ver. 1.4 and various operation commands defined by a vender.

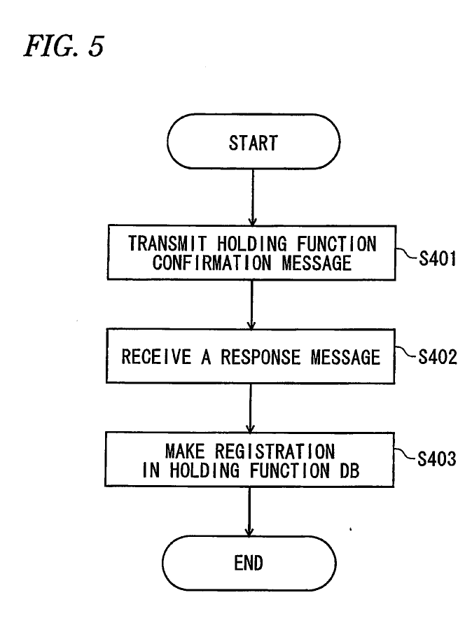

Next, processing as to transmission of a holding function confirmation message to be performed by the display device 200 will be described with reference to FIG. 5.

First, the HDMI communication controller 231 transmits a holding function confirmation message, e.g. as shown in FIG. 3A, to the video output device 300 (S401). When the HDMI communication controller 231 receives a holding function notification message which is a response to the holding function confirmation message, e.g. as shown in FIG. 3B (S402), the HDMI communication controller 231 registers a holding function database 2321 concerned with a function held by the video output device 300 into the storage module 232 based on information about the function provided by the video output device 300 and included in the holding function notification message (S403).

Although description in FIG. 5 has been given to the case where the display device 200 transmits the holding function confirmation message to the video output device 300, the video output device 300 may alternatively transmit the message to the display device 200, receive a response message from the display device 200, and create a database based on information about a function provided by the display device 200 and included in the response message.

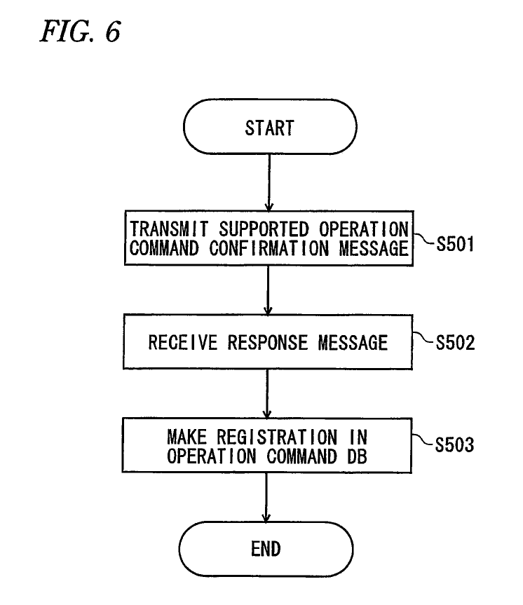

Next, processing as to transmission of an operation command support confirmation message to be performed by the display device 200 will be described with reference to FIG. 6.

First, the HDMI communication controller 231 transmits an operation command support confirmation message, e.g. as shown in FIG. 3C, to the video output device 300 (S501). When the HDMI communication controller 231 receives an operation command support notification message which is a response to the operation command support confirmation message, e.g. as shown in FIG. 3D (S502), the HDMI communication controller 231 registers an operation command database 2322 concerned with an operation command which can be used by the video output device 300, into the storage module 232 based on information about the operation command supported by the video output device 300 and included in the operation command support notification message (S503).

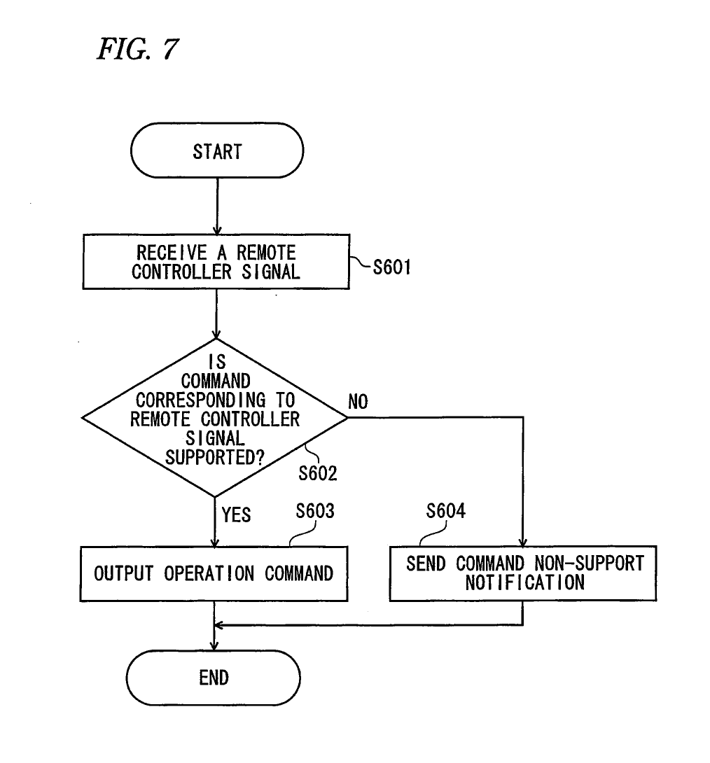

Next, a flow example of processing when the display device 200 receives a signal from the remote controller 100 will be described with reference to FIG. 7.

First, when the signal receiver 211 receives a signal from the remote controller 100 (S601), the HDMI communication controller 231 refers to the operation command database 2322 of the storage module 232, and determines whether the video output device 300 supports an operation command corresponding to a remote controller code superposed on the signal (S602). When the video output device 300 supports the operation command (Yes in S602), the HDMI communication controller 231 transmits the operation command to the video output device 300 (S603). On the other hand, when the video output device 300 does not support the operation command, the HDMI communication controller 231 instructs the GUI processor 241 to create a report screen, and controls the display module 243 to display the report screen (S604).

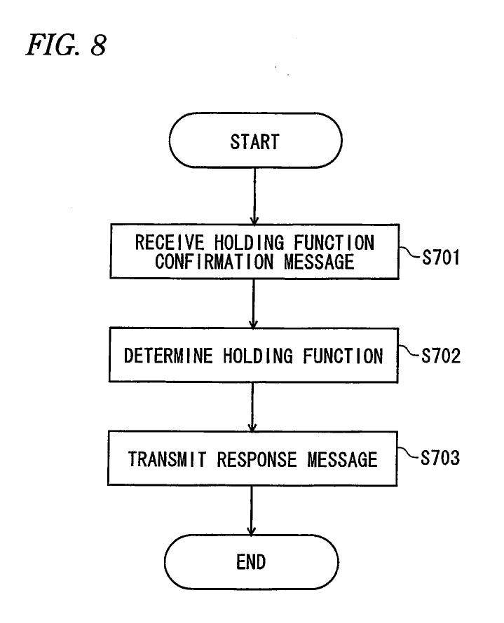

Next, a flow example of processing when the video output device 300 receives a holding function confirmation message will be described with reference to FIG. 8.

First, when the HDMI communication controller 331 receives a holding function confirmation message from the display device 200, e.g. as shown in FIG. 3A (S701), the HDMI communication controller 231 determines whether the video output device 300 has a function designated by the message or not (S702). The HDMI communication controller 331 transmits, to the display device 200, a holding function notification message including information as to whether the video output device 300 holds the function or not, as a response to the holding function confirmation message, e.g. as shown in FIG. 3B (S703).

Although description in FIG. 8 has been given to the case where the video output device 300 receives the holding function confirmation message from the display device 200, the display device 200 may alternatively receive the message from the video output device 300, determine whether the display device 200 has a function requested for confirmation by the message or not, and output a holding function notification message including information as to whether the display device 200 has the function or not, to the video output device 300.

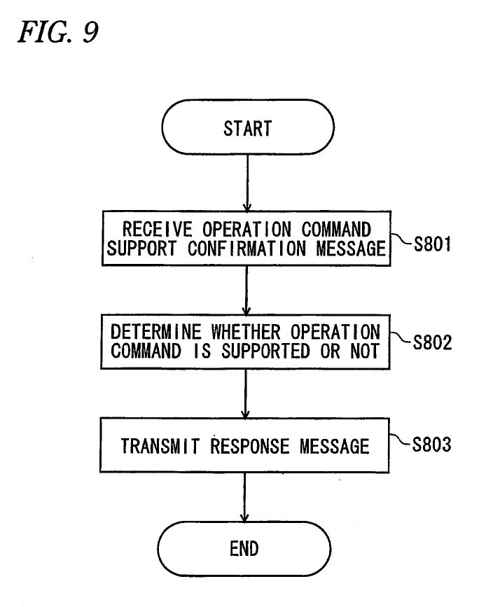

Next, a flow example of processing when the video output device 300 receives an operation command support confirmation message will be described with reference to FIG. 9.

When the HDMI communication controller 331 receives an operation command support confirmation message, e.g. as shown in FIG. 3C (S801), the HDMI communication controller 331 determines whether the video output device 300 supports an operation command designated by the message (S802), and transmits, to the display device 200, an operation command support notification message including information as to whether the video output device 300 supports the operation command or not, e.g. as shown in FIG. 3C (S803).

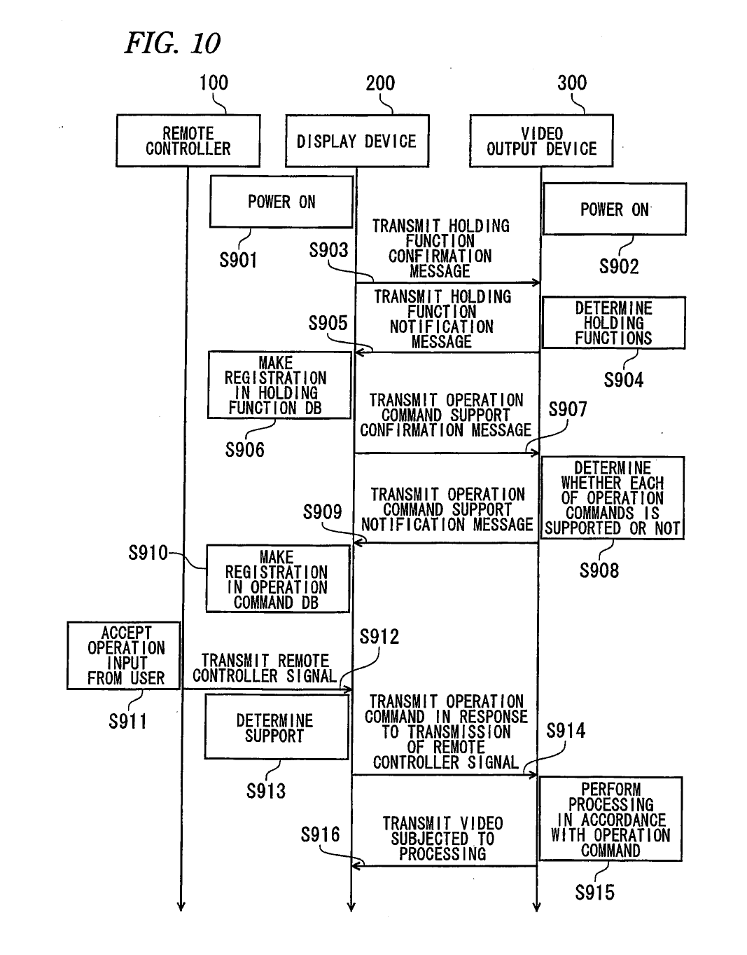

Next, a flow example of processing to be performed by the remote controller 100, the display device 200 and the video output device 300 will be described with reference to FIG. 10.

First, when power supply to the display device 200 and the video output device 300 starts (S901 and S902), communication connection between the display device 200 and the video output device 300 is established and the display device 200 transmits a holding function confirmation message to the video output device 300 (S903). Upon reception of the message, the video output device 300 determines functions held by itself (S904), and transmits a holding function notification message concerned with the functions provided by itself to the display device 200 (S905). Upon reception of the holding function notification message from the video output device 300, the display device 200 creates/registers a holding function database 2321 concerned with the functions provided by the video output device 300, based on the message (S906).

Then, the display device 200 transmits an operation command support confirmation message for inquiring operation commands which can be used by the video output device 300, to the video output device (S907). The display device 200 may alternatively inquire operation commands to be used in the case where the display device 200 uses one of the functions held by the video output device 300. That is, when, for example, the video output device 300 has a DVD function, the display device 200 may confirm whether or not the video output device 300 supports operation commands for using the DVD function, i.e. commands such as a DVD play command and a stop command.

Upon reception of the message, the video output device 300 determines operation commands supported by the video output device 300 (S908), and sends an operation command support notification message as to the operation commands which can be used by the video output device 300, to the display device 200 (S909). Upon reception of the notification message, the display device 200 registers an operation command database 2322 concerned with the operation commands which can be used by the video output device 300, into the storage module 232 based on the message (S910).

The remote controllers 100 accepts an operation input from a user (S911), and transmits a signal having a remote controller code superposed thereon based on the operation input, to the display device 200 (S912). When the display device 200 receives the signal, the display device 200 refers to the holding function database 2321 and the operation command database 2322, and determines whether an operation command corresponding to the remote controller code contained in the signal can be used by the video output device 300 or not (S913). When the operation command can be used, by the video output device 300, the display device 200 transmits the operation command to the video output device 300 (S914). When the video output device 300 does not support the operation command, the display device 200 reports the fact that the video output device 300 does not support the operation command (not shown in FIG. 10).

When the video output device 300 receives the operation command from the display device 200, the video output device 300 performs processing in accordance with the command (S915), and transmits video having the processing reflected thereon to the display device 200 (S916). For example, the video having the processing reflected thereon is expressed as a video image of a program guide in the case where the video output device 300 receives a program guide display command, or video to be played back in the case where the video output device 300 receives a play command.

Description in FIG. 10 has been given to the case where the display device 200 can send the holding function confirmation message and the operation command support confirmation message before reception of a signal from the remote controller 100, However, message sending timing in the present embodiment of the invention is not limited thereto. For example, the display device 200 may send an operation command support confirmation message concerned with an operation command corresponding to a remote controller code of a signal from the remote controller 100 when the signal is received from the remote controller 100.

Further, when the video output device 300 receives the operation command support confirmation message and supports an operation command designated by the message, the video output device 300 may perform processing in accordance with the operation command. That is, when, for example, the video output device 300 receives an operation command support confirmation message as to whether the video output device 300 supports a program guide display command or not, and the video output device 300 supports the program guide display command, the video output device 300 may perform table guide display processing in accordance with the command.

Although description in FIG. 10 has been given to the case where the display device 200 transmits a holding function confirmation message and then transmits an operation command support confirmation message when the display device 200 and the video output device 300 have been powered on, an operation command support confirmation message may be alternatively transmitted when, for example, the display device 200 and the video output device 300 have been powered on.

It is advantageous that the holding function confirmation message and the operation command support confirmation message are transmitted before a signal is received from the remote controller 100, i.e. when the display device 200 and the video output device 300 have been powered on, so that upon reception of the signal from the remote controller 100, the display device 200 can quickly determine whether the video output device 300 supports an operation command corresponding to a remote controller code of the signal or not.

Although the embodiment has been described in the case where the display device 200 receives a remote controller signal and then transmits a control command in accordance with the signal to the video output device 300, the video output device 300 may alternatively receive a remote controller signal and transmits a control command in accordance with the signal to the display device 200. In addition, the video output device 300 may transmit a function confirmation message and an operation command confirmation message to the display device 200, and the display device 200 may determine support/non-support of operation commands and presence/absence of functions in response to the messages, and transmit response messages to the video output device 300 based on results of the determination.

### Second Embodiment

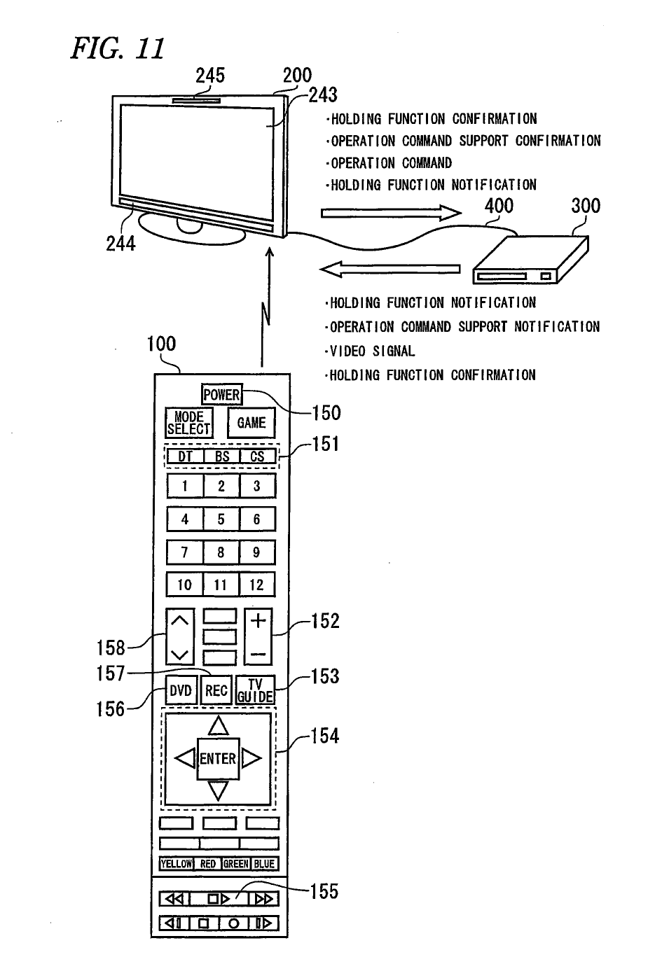

A second embodiment will be described next with reference to FIGS. 11 and 12 and FIGS. 13A to 13C.

As shown in FIG. 11, an electronic device according to the second embodiment is implemented, for example, as a combination of a display device 200 and a video output device 300. The display device 200 and the video output device 300 are connected to each other by an HDMI cable 400. The display device 200 displays video outputted from the video output device 300. A remote controller 100, the display device 200, the video output device 300 and the HDMI cable 400 according to the second embodiment have the same configurations and functions as those described in the first embodiment.

That is, the remote controller 100 accepts an operation input on one of various buttons and transmits a signal on which a remote controller code corresponding to the operation input is superposed. Upon reception of this signal transmitted from the remote controller 100, the display device 200 outputs a control command corresponding to the remote controller code superposed on this signal to the video output device 300 through the HDMI cable 400 to thereby make it possible to control the operation of the video output device 300.

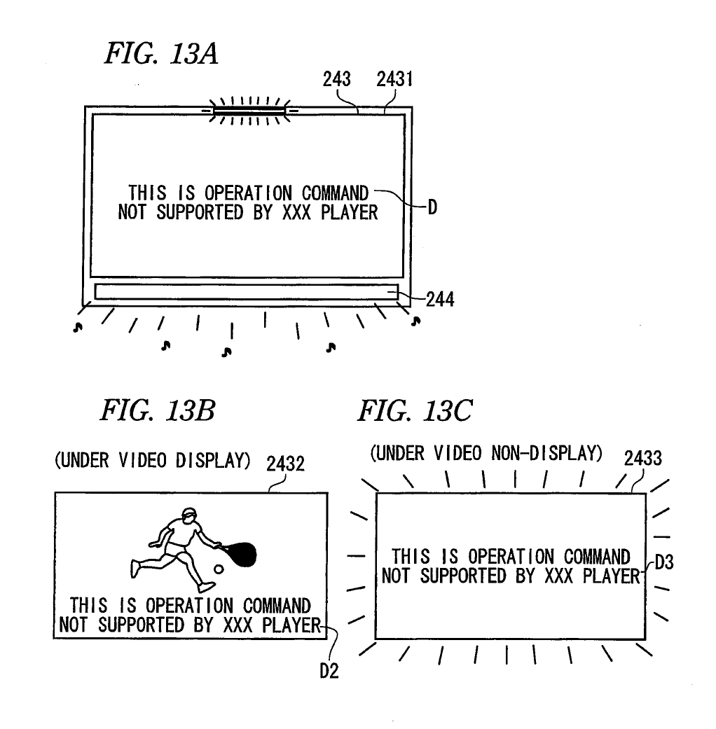

The display device 200 according to the second embodiment has a housing 250. A display module 243, a speaker module 244, an indicator 245, etc. are provided in a front surface of the housing 250. The display module 243 is a display such as an LCD which displays video of video data inputted from the video output device 300 and various report screens. Incidentally, details of report screens will be described later with reference to FIGS. 13A to 13C. The speaker module 244 outputs audio of audio data inputted from the video output device 300 and an alarm sound to the surroundings of the display device 200. The indicator 245 is, for example, a light or display capable of being switched on/off and has a function as an indicating device for reporting various kinds of notifications or the like.

When the display device 200 according to the second embodiment receives a signal with a remote controller code superposed thereon from the remote controller 100, the display device 200 can perform reporting to a user in accordance with whether a control command corresponding to the remote controller code is supported by the video output device 300 or not.

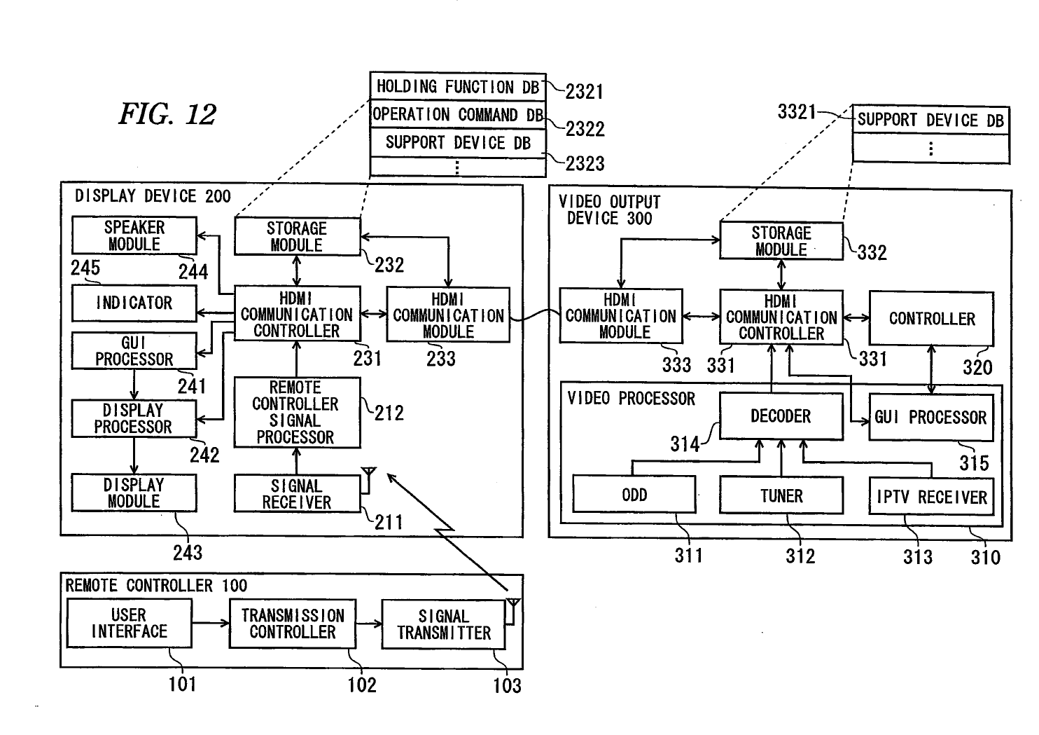

An example of system configuration of the display device 200 according to the second embodiment will be described next with reference to FIG. 12. Incidentally, since the system configuration and respective configuration functions of the remote controller 100 and the video output device 300 in the second embodiment are the same as those in the first embodiment, description thereof will be omitted. As for respective configurations of the display device 200, configurations and functions different from those in the first embodiment will be described chiefly.

The display device 200 has a signal receiver 211, a remote controller signal processor 212, an HDMI communication controller 231, a storage module 232, an HDMI communication module 233, a GUI processor 241, a display processor 242, a display module 243, a speaker module 244, an indicator 245 etc. The signal receiver 211, the remote controller signal processor 212, the storage module 232, the HDMI communication module 233, the GUI processor 241, the display processor 242 and the display module 243 have the same functions as those described in the first embodiment.

That is, the signal receiver 211 receives a single from the remote controller 100. The remote controller signal processor 212 processes a remote controller code superposed on the signal received by the signal receiver 211, and outputs the remote controller code to the HDMI communication controller 231.

The HDMI communication controller 231 controls processing concerned with establishment of HDMI communication connection with the video output device 300 connected through the HDMI cable 400, transmission/reception of any command to/from the video output device 300, reception of video data from the video output device 300, etc.

The HDMI communication controller 231 transmits a holding function confirmation message and an operation command support confirmation message to the video output device 300 to inquire of the video output device 300 about functions provided by the video output device 300 and inquire of the video output device 300 about operation commands supported by the video output device 300. Upon reception of a response to the holding function confirmation message and a response to the operation command support confirmation message, the HDMI communication controller 231 creates a holding function database 2321 and an operation command database 2322 and stores the databases 2321 and 2322 in the storage module 232.

When a remote controller code is inputted from the remote controller signal processor 212, the HDMI communication controller 231 refers to the operation command database 2322 to thereby determine whether a control command corresponding to the remote controller code is supported by the video output device 300 or not. When the operation command is not supported by the video output device 300, the HDMI communication controller 231 instructs the GUI processor 241 to create a report screen. When the operation command is not supported by the video output device 300, the HDMI communication controller 231 may instruct the speaker module 244 and the indicator 245 to execute reporting.

When the HDMI communication controller 231 receives a response to the holding function confirmation message and a response to the operation command support confirmation message so that device information of the video output device 300 is contained in each response, the HDMI communication controller 231 determines whether information about a device corresponding to the device information is stored in the operation command database 2322 or not. When information about a device corresponding to the device information contained in each response is stored in the operation command database 2322, the HDMI communication controller 231 may determine whether the corresponding device supports all control commands allowed to be transmitted by the display device 200 or not.

The storage module 232 stores the holding function database 2321 and the operation command database 2322. The holding function database 2321 and the operation command database 2322 are the same databases as those in the first embodiment. Not only these databases may be created and stored based on a holding function notification message and an operation command support notification message given from the video output device 300 but also these databases may be stored in advance at the time of factory shipment or may be registered and stored by firmware updating or user inputting.

The operation command database 2322 may store information indicating whether a device connected to the display device 200 through the HDMI communication module 233 supports all control commands allowed to be transmitted by the display device 200 through the HDMI communication module 233 or not.

The display device 200 outputs a control command corresponding to the remote controller code given from the remote controller 100, to a device such as the video output device 300 connected to the display device 200 through the HDMI communication module 233. When, for example, the remote controller 100, the display device 200 and the video output device 300 are devices provided by the same vendor on this occasion, the video output device 300 may support all HDMI-CEC control commands corresponding to respective remote controller codes which can be transmitted to the display device 200 by the remote controller 100.

A support device database 2323 can store information as to whether a device supports all control commands corresponding to remote controller codes allowed to be transmitted to the display device 200 by the remote controller 100 or not, that is, whether a device supports all control commands allowed to be transmitted by the display device 200 through the HDMI communication module 233 or not, while the information is associated with an ID, a device name, etc. of each device.

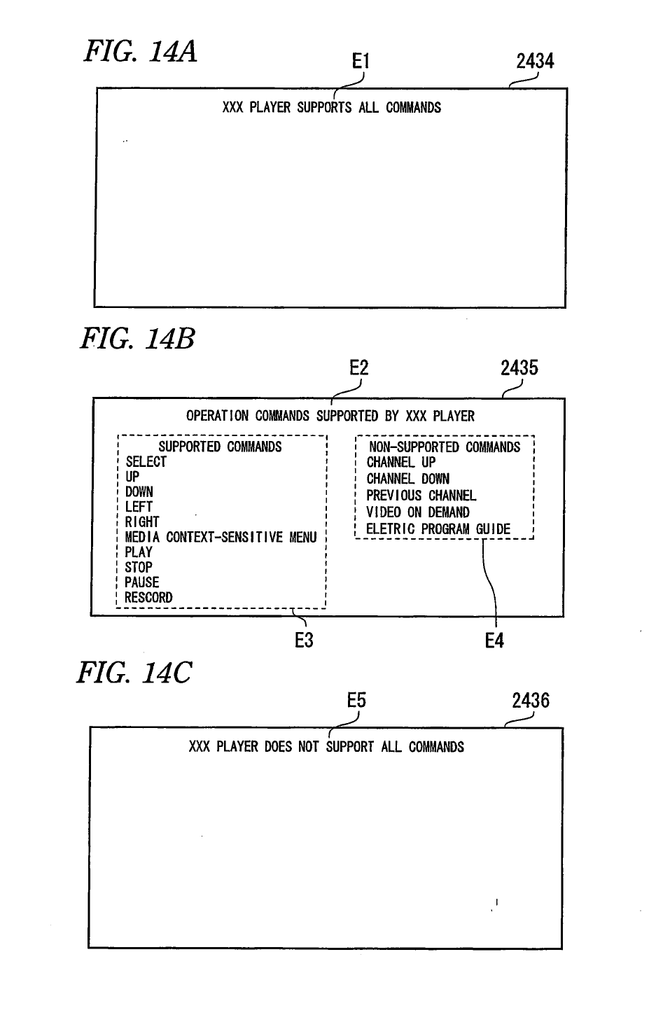

When the GUI processor 241 receives a report screen creation instruction from the HDMI communication controller 231, the GUI processor 241 creates a report screen based on the instruction and outputs data of the created screen to the display processor 242. Even when there is no report screen creation instruction received from the HDMI communication controller 231, the GUI processor 241 may create a report screen, for example, concerned with the operation command supported by the video output device 300 and output the created report screen to the display processor 242. Incidentally, the report screen created by the GUI processor 241 will be described later with reference to FIGS. 13A to 13C and FIGS. 14A to 14C.

The display processor 242 converts video data inputted from the HDMI communication controller 231 and screen data inputted from the GUI processor 241 into a video signal for display and outputs the video signal to the display module 243. The display module 243 displays video based on the video signal inputted from the display processor 242.

When the speaker module 244 receives an alarm sound output instruction from the HDMI communication controller 231, the speaker module 244 output an alarm sound. When the indicator 245 receives a report instruction, the indicator 245 reports the fact that the operation command is not supported by the video output device 300, for example, by switching on/off a light.

An example of operation of the display device 200 when the display device 200 receives a signal from the remote controller 100 but the video output device 300 does not support an operation command corresponding to a remote controller code superposed on this signal will be described next with reference to FIGS. 13A to 13C.

FIG. 13A is a view showing an example of a report operation executed by the display device 200. When the video output device 300 does not support an operation command corresponding to the remote controller code superposed on the signal received from the remote controller 100, the display device 200 executes various kinds of report operations. On this occasion, as shown in FIG. 13A, the display device 200 executes a report operation, for example, in such a manner that the display module 243 displays a report screen 2431, the speaker module 244 outputs an alarm sound, and the indicator 245 is switched on. Incidentally, a report image D1 indicating the fact that the operation command is not supported by the video output device 300 is displayed on the report screen 2431. The image D1 may indicate a device name of the video output device 300.

FIG. 13B is a view showing an example of a report screen when an image on a report screen and an image different from the image on the report screen are displayed together by the display device 200. When a report screen is displayed while video of video data transmitted from the video output device 300 is displayed, the display device 200 displays a report screen 2432 on which an image of video data inputted from the HDMI communication controller 231 and a report image D2 created by the GUI processor 241 are displayed together.

On this occasion, the GUI processor 241 creates screen data so that the report image D2 indicating the fact that the operation command is not supported by the video output device 300 is disposed in a lower end module of the screen. The display processor 242 creates a video signal by superposing the screen data created by the GUI processor 241 on the video data inputted from the HDMI communication controller 231, so that the display module 243 displays a report screen 2432 based on the video signal. Incidentally, the GUI processor 241 need not create such screen data based on which the report image D2 is disposed in the lower end module of the screen. For example, the GUI processor 241 may create screen data based on which the report image D2 is disposed in an upper end module of the screen or in a left or right end module of the screen.

FIG. 13C is a view showing an example of a report screen displayed when video of video data transmitted from the video output device 300 is not displayed by the display device 200.

When the display module 243 does not display video of video data transmitted from the video output device 300 in the case where the GUI processor 241 receives a report screen creation instruction from the HDMI communication controller 231, the GUI processor 241 creates screen data based on which a report image D3 is disposed in the center of the screen. The display module 243 displays a report screen 2433 based on the screen data. Incidentally, the size (resolution) of the report image D3 may be larger than the size of the report image D2. The display module 243 may display the report screen 2433 so that, for example, the report screen 2433 is blinked on and off.

An example of a report screen concerned with operation commands supported by the video output device 300 will be described next with reference to FIGS. 14A to 14C.

FIG. 14A shows an example of a report screen displayed by the display device 200 when the video output device 300 supports all operation commands transmitted by the display device 200 in accordance with remote controller codes from the remote controller 100. In this case, a report image E1 indicating the fact that the video output device 300 supports all commands is disposed on a report screen 2434. Although the report screen E1 may be disposed in any position of the display screen, the report screen E1 may be disposed in an end module such as a lower end module or an upper end module of the display screen when, for example, the display device 200 displays video of video data transmitted from the video output device 300.

FIG. 14B shows an example of a report screen displayed by the display device 200 when the video output device 300 supports at least one part of operation commands transmitted by the display device 200 in accordance with remote controller codes from the remote controller 100. In this case, a support command image E3 indicating operation commands supported by the video output device 300 and a non-support command image E4 indicating operation commands not supported by the video output device 300 are disposed on a report screen 2435.

FIG. 14C shows an example of a report screen displayed by the display device 200 when the video output device 300 does not support all operation commands transmitted by the display device 200 in accordance with remote controller codes from the remote controller 100. In this case, a report image E5 indicating the fact that the video output device 300 does not support commands at all is disposed on a report screen 2436.

Incidentally, when the display device 200 receives a holding function notification message and an operation command support notification message from the video output device 300, the display device 200 may display these report screens 2434 to 2436. Or when HDMI communication connection between the display device 200 and the video output device 300 is completed or the display device 200 receives a display request input from the user, the display device 200 may display these report screens 2434 to 2436.

Incidentally, the display device 200 displays the report screens 2434 to 2436 shown in FIGS. 14A to 14C, for example, in the step S604, etc. in FIG. 7 described in the first embodiment. On this occasion, the display device 200 can output a screen in accordance with the case where the video output device 300 supports all operation commands allowed to be transmitted by the display device 200 in accordance with remote controller codes from the remote controller 100, the case where the video output device 300 supports a part of the operation commands or the case where the video output device 300 does not support the operation commands at all. The display device 200 may display a report screen on which names of operations corresponding to support/non-support operation commands supported by the video output device 300, that is, for example, names of buttons of the remote controller 100 etc. are displayed. That is, when, for example, the video output device 300 supports operation commands for requesting program guide display, the display device 200 may display a report screen on which the fact that the video output device 300 supports a program guide display button 153 of the remote controller 100 is displayed.

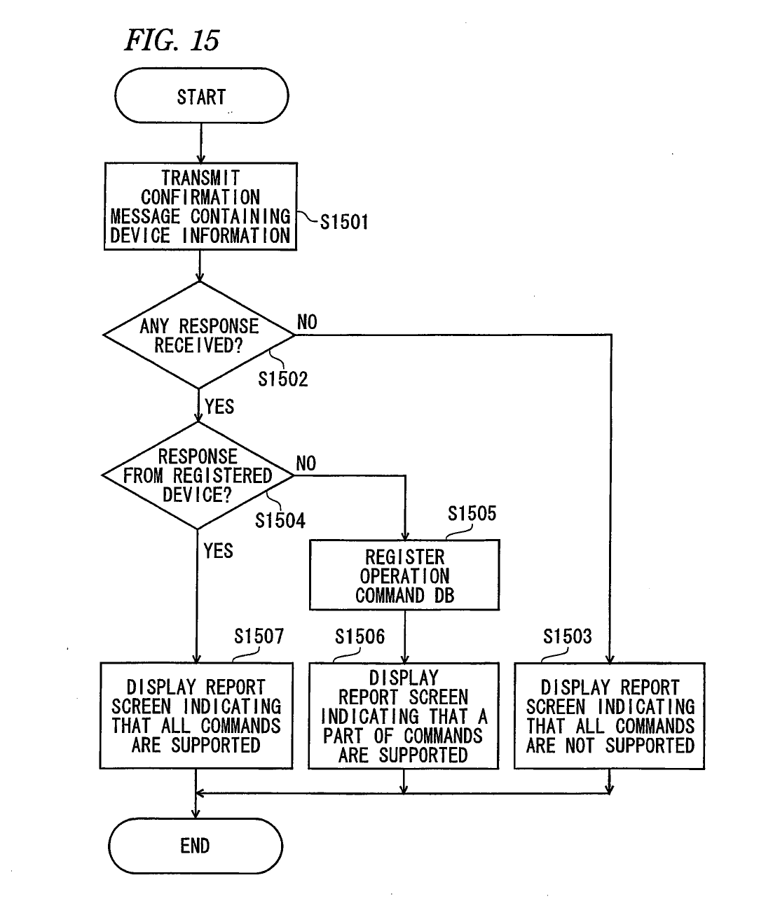

An example of a processing flow in the case where the display device 200 displays a report screen for operation commands supported by the video output device 300 will be described next with reference to FIG. 15.

First, the display device 200 transmits an operation command confirmation message to the video output device 300 (S1501). When there is not received any response to the confirmation message (No in S1502), the display device 200 displays a report screen such as a report screen 2436 shown in FIG. 14C (S1503). On the other hand, when an operation command notification message which is a response to the confirmation message is received in S1502, the display device 200 determines whether device information such as a device name, a device ID, etc. of the video output device 300 is contained in the notification message or not. When device information is contained in the notification message, the display device 200 determines whether the device indicated by the device information is a device supporting all control commands registered in the operation command database 2322 and transmitted by the display device 200 in accordance with remote controller codes from the remote controller 100 or not (S1504).

When the video output device 300 is not a device supporting all control commands transmitted by the display device 200 (No in S1504), the display device 200 registers an operation command database 2322 for operation commands allowed to be used by the video output device 300 in the storage module 232 based on the operation command notification message from the video output device 300 (S1505). The display device 200 displays a report screen such as a report screen 2435 shown in FIG. 14B (S1506).

On the other hand, when the video output device 300 is a device supporting all control commands transmitted by the display device 200 (Yes in S1504), the display device 200 displays a report screen such as a report screen 2436 shown in FIG. 14C (S1507) and the processing flow is completed.

Incidentally, not only when the video output device 300 according to each of the first and second embodiments receives a confirmation message such as a holding function confirmation message or an operation command support confirmation message from the display device 200 but also when the video output device 300 receives a control command such as an operation command from the display device 200, the video output device 300 may determine whether the video output device 300 itself supports the command or not, and execute processing in accordance with the support/non-support.

That is, when a control command such as an operation command received from the display device 200 is supported by the video output device 300 itself, the video output device 300 may execute processing indicated by the command and transmit a support notification command indicating the fact that the video output device 300 supports the control command, to the display device 200. When a control command received from the display device 200 is not supported by the video display device 300, the video output device 300 may transmit a non-support notification command indicating the fact that the video output device 300 does not support the control command, to the display device 200. That is, when operation commands designating operations and an operation command support confirmation message designating operation commands or operations are received from the display device 200, the video output device 300 can determine whether operation commands designated by these commands are supported by the video output device 300 or not, and transmit the notification of support/non-support to the display device 200.

When the display device 200 transmits a control command such as an operation command to the video output device 300 and then does not receive any support notification command with respect to the command or receives a non-support notification command on this occasion, the display device 200 may perform a report operation for reporting the fact that the video output device 300 does not support the control command.

When an operation command transmitted from the display device 200 is not supported by the video output device 300, the video output device 300 may transmit video data and audio data of video and audio indicating the fact that the command is not supported by the video output device 300, to the display device 200. Incidentally, on this occasion, the video output device 300 outputs at least one of video data and audio data to the display device 200. In this case, the display device 200 displays video of received video data and outputs audio of received audio data to thereby report the fact that the operation command is not supported by the video output device 300.

According to the first and second embodiments, when a signal is received from the remote controller 100, the display device 200 can perform processing in accordance with whether a control command corresponding to a remote controller code superposed on this signal is supported by the video output device 300 or not, so that user friendliness can be improved.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An electronic device that transmits an operation command to an external device to control an operation of the external device, the device comprising:
a first communication module configured to:
transmit a confirmation request to the external device to confirm whether the external device supports the operation command or not; and
receive, from the external device, a response including information as to whether the external device supports the operation command or not;
a receiver configured to receive a remote controller signal from a remote controller;
a second communication module configured to transmit the operation command corresponding to the remote controller signal, to the external device; and
a reporting module configured to report that the operation command is not supported by the external device, when the response includes the information that the operation command is not supported by the external device.

2. The electronic device of claim 1, wherein
the first communication module is configured to transmit the confirmation request to the external device to confirm whether the external device supports each of a plurality of operation commands or not.

3. The electronic device of claim 1, wherein
the first communication module is configured to transmit the confirmation request to the external device to confirm whether the external device supports the operation command corresponding to the remote controller signal or not, when the receiver receives the remote controller signal.

4. The electronic device of claim 1, further comprising:
a storage module configured to store the information as to whether the external device supports the operation command or not, and
wherein the execution module is configured to report that the external device does not support the operation command corresponding to the remote controller signal, when the information indicates that the external device does not support the operation command corresponding to the remote controller signal.

5. The electronic device of claim 1, further comprising:
a third communication module configured to:
transmit a confirmation request to the external device to confirm whether the external device has a specific function or not; and
receive, from the external device, a response including information as to whether the external device has the specific function or not.

6. The electronic device of claim 5, wherein
the third communication module is configured to transmit the confirmation request to the external device when the electronic device and the external device are powered on.

7. The electronic device of claim 5, wherein
the first communication module is configured to transmit the confirmation request to the external device to confirm whether or not the external device supports an operation command for the specific function, after the third communication module receives the response.

8. The electronic device of claim 1, further comprising:
a display module configured to display images,
wherein the reporting module is configured to report that the operation command is not supported by the external device, by controlling the display module to display a first image.

9. The electronic device of claim 8, wherein
the reporting unit is configured to control the display unit to display the first image in an end portion of a display screen of the display module.

10. The electronic device of claim 9, further comprising:
a video receiver configured to receive video data from the external device,
wherein the display unit is configured to display a video generated from the video data, and
the reporting module is configured to control the display module to display the first image in the end portion of the display module when the display module is displaying the video.

11. The electronic device of claim 1, further comprising:
a speaker module configured to output an audio,
wherein the reporting module is configured to report that the operation command is not supported by the external device, by controlling the speaker unit to output first audio.

12. An electronic device that transmits an operation command to an external device to control an operation of the external device, the device comprising:
a receiver configured to receive a confirmation request from the external device to confirm whether the electronic device supports the operation command or not; and
a transmitter configured to transmit, to the external device, a response including information as to whether the electronic device supports the operation command or not, when the receiver receives the confirmation request.

13. The electronic device of claim 12, further comprising:
an execution module configured to execute a specific processing corresponding to the operation command, when the receiver receives the confirmation request and the electronic device supports the operation command.

14. A method of controlling an electronic device, which transmits an operation command to an external device to control an operation of the external device, the method comprising:
(a) transmitting a confirmation request to the external device to confirm whether the external device supports the control command or not;
(b) receiving, from the external device, a response including information as to whether the external device supports the operation command or not;
(c) receiving a remote controller signal from a remote controller; and
(d) transmitting the operation command corresponding to the remote controller signal, to the external device; and
(e) reporting that the operation command is not supported by the external device, when the response includes the information that the operation command is not supported by the external device.
